(19) United States
(12) Patent Application Publication
(10) Pub. No.: US 2009/0321977 A1
(43) Pub. Date: Dec. 31, 2009

(54) METHOD FOR ENCAPSULATING THE EDGE OF A GLASS SHEET

(75) Inventors: Luigi Capriotti, San Benedetto del Tronto (IT); Ciro Paudice, Vasto (IT)

Correspondence Address: BUCHANAN, INGERSOLL & ROONEY PC, POST OFFICE BOX 1404, ALEXANDRIA, VA, 22313-1404, US

(73) Assignee: PILKINGTON ITALIA S.P.A., San Salvo (IT)

(21) Appl. No.: 12/439,078

(22) PCT Filed: Aug. 31, 2007
(86) PCT No.: PCT/EP2007/007629

§ 371 Date: Apr. 13, 2009

(30) Foreign Application Priority Data
Aug. 31, 2006 (EP) 06425604.3

(51) Int. Cl. B29C 41/22; B60J 10/00; B29C 41/50; B29C 41/42

(52) U.S. Cl. 264/101; 264/267

(57) ABSTRACT

A method of providing the periphery of a glazing with a gasket by moulding using a mould having at least one moulding surface is disclosed. The method comprises forming the gasket from polyurethane precursors by contacting the glazing with the precursors and allowing the precursors to polymerise and harden. The moulding surface is provided with a releasable coating in an aqueous solution. The coating bonds with the polyurethane during polymerisation such that it is incorporated into the gasket, and prevents the polyurethane from coming into contact with the moulding surface to which it has been applied.

The present invention relates to moulds used in low pressure injection moulding processes, in particular, to moulds used in the encapsulation of automotive glazings.

In order to be fitted into a vehicle, an automotive glazing is provided with a gasket adhered to the periphery of the glazing. The gasket performs a four-fold function: firstly, it provides a spacer to ensure that the glazing is spaced a constant distance apart from the vehicle body at any point; secondly, it provides a bed onto which adhesive can be placed to secure the glazing into the vehicle body; thirdly, it provides a watertight seal between the glazing and the vehicle body; and fourthly, it conceals the adhesive from view and damage by sunlight. The gasket may be provided by extrusion, for example, using polyurethane or a thermoplastic polymer, by adhering a pre-formed part to the glass, or by injection moulding. The requirements of the automotive glazing market are such that gaskets and other preformed components are provided on the glazing by the glazing manufacturer, and sold to a vehicle manufacturer as a fully finished part.

Reaction injection moulding (RIM) has been used extensively within the automotive industry to mould gaskets onto automotive glazings. For example, EP 0 156 882 describes a RIM process for the manufacture of an automotive glazing and gasket assembly where polyurethane is injected into a metal mould clamped around the glazing. The main advantage of using the RIM method is the speed at which the mould is filled, coupled with the setting time of the polyurethane, so that a finished glazing is obtained in less than 90 seconds. In addition, other, preformed parts required that need to be adhered to the surface of the glazing, such as studs, spacers, or other metal or plastic parts, can be placed into the mould before the polyurethane is injected. The general moulding process is commonly known as encapsulation.

Metal moulds are used to withstand the high pressures necessary to enable the injection of polyurethane. However, one major disadvantage is that metal moulds are very expensive. This is mainly due to the complex manufacturing process and the tight tolerances necessary to enable a glazing to be placed into the mould without breaking. In addition, it may be necessary to apply anti-sticking or release agents to the inner surfaces of the moulds to enable the finished glazing to be removed without damage to the gasket.

As an alternative to metal moulds for encapsulation, other mould materials have been proposed. EP 0 792 209 discloses the use of a mould made of a plastic material, in a RIM process for encapsulating automotive glazings. A polyurethane fluoride elastomer; silicone elastomer and/or fluoride silicone elastomer; or a layer of a fluoride silicone elastomer on a silicone elastomer can be used to form the mould. By using low-cost mould materials, coupled with a polyurethane mix which can be applied to glass under low or atmospheric pressure and has a fast gelling time, the disadvantages of the metal RIM moulds are overcome, whilst preserving the advantages.

However, one disadvantage of using silicone-based moulds is that such moulds have a relatively short working lifetime compared with metal moulds. A typical silicone mould may be used for less than 150 encapsulations, before needing replacement. One problem is mould shrinkage, due to repeated contact with the polyurethane, which may be overcome in part by mixing glass microspheres with the elastomer material used to make the mould Additionally, a thin metal layer can be applied to the surface of the mould in order to prevent damage. However, neither of these measures leads to an overly prolonged mould life. A second problem is that the polyurethane used to mould the gasket penetrates the surface pores the silicone mould. Eventually, when enough pores have been saturated, regions of the surface of the gasket remain adhered to the mould surface when the glazing is removed, creating an aesthetically unacceptable finish. Once this occurs, the mould is removed from production, and a further mould cast on a master former. Depending on many factors, inclining part complexity and annual production volume, the cost of manufacturing and/or repairing these moulds and of purchasing and disposing of silicone may be less than that of the metal moulds used in traditional high pressure technology. However, the repeated stops in production caused by the frequent silicone mould replacements may minimise or nullify the economic advantages.

There is therefore a need for a mould, suitable for use in RIM moulding of automotive glazings, which has an increased lifetime compared with conventional silicone moulds, and a decreased cost per part compared with those made in metal moulds.

The present invention aims to address this problem by providing a method of providing the periphery of a glazing with a gasket by moulding using a mould having at least one moulding surface, comprising:
forming the gasket from polyurethane precursors by contacting the glazing with the precursors and allowing the precursors to polymerise and harden;
wherein the moulding surface is provided with a releasable coating in an aqueous solution, the coating bonding with the polyurethane during polymerisation such that it is incorporated into the gasket, and preventing the polyurethane from coming into contact with the moulding surface to which it has been applied.

By providing a releasable coating which acts as a barrier layer between the mould material and the polyurethane and is continually replaced, problems of mould contamination are avoided. By replacing the releasable coating, each moulding encounters a fresh mould surface, giving optimum results, and the lifetime of the mould is increased. By incorporating the releasable coating into the gasket, a finished part which does not need further treatment, such as washing, is obtained, and wide variety of surface finishes are available.

Preferably, the mould comprises complementary first and second half moulds, each having a moulding surface for moulding the gasket onto the periphery of the glazing, the method further comprises placing a glazing between the complementary first and second half moulds; closing the complementary first and second half moulds together and sealing the glazing between them such that the moulding surfaces form a cavity corresponding to the gasket to be moulded; filling the cavity with polyurethane precursors; allowing the polyurethane precursors to polymerise and harden; and removing the glazing having a gasket moulded thereon.

Preferably, the releasable coating does not react with the moulding surface of the half mould to which it is applied.

Preferably, the polyurethane precursors comprise: (a) prepolymer composition formed from the reaction product of isocyanate and polyols, and (b) a chain extender. Preferably, the polyurethane precursors form a mix having a short gelling time and enter the mould under low or atmospheric pressure.

Preferably the releasable coating is one of: aqueous solutions of waxes; aqueous solutions of polyurethane resins; hydro-alcoholic solutions of polyurethane resins; aqueous solutions of aliphatic polyurethane resins; or aqueous solutions of acrylic resins.

Preferably the moulding surface of the mould half having the releasable coating applied is formed from silicone.

Preferably the releasable coating is applied to the mould half by spraying, dipping or painting.

Preferably the aqueous solvent is evaporated off before placing the glazing into the mould.

The present invention will now be described by way of example only, and with reference to the accompanying drawings, in which:

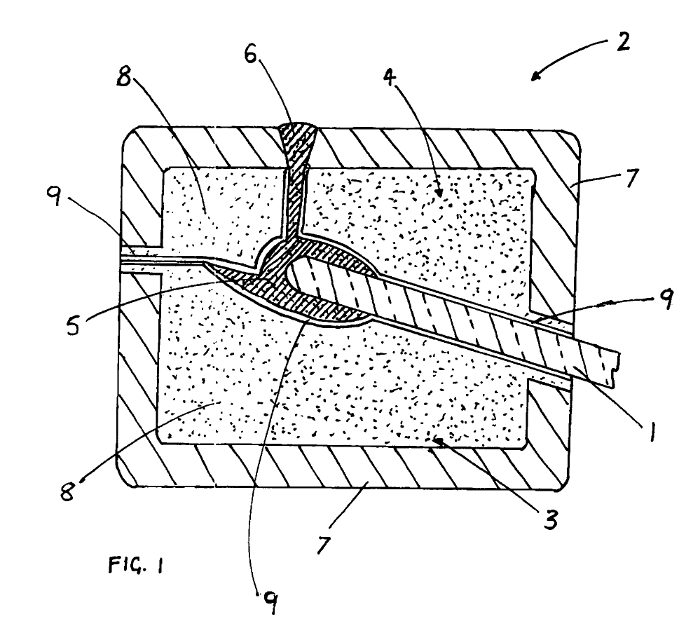

FIG. 1 is a cross-section showing the two halves of a mould clamped around a glazing; and

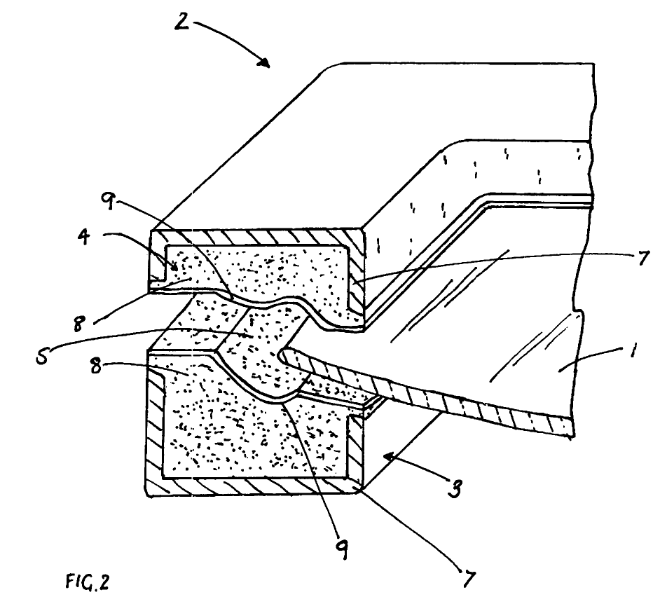

FIG. 2 is a perspective view showing the two halves of a mould clamped around a glazing.

As shown in FIG. 1, in order to provide a gasket around the periphery of a glazing 1, the glazing 1 is placed into a mould 2. The mould 2 comprises two complementary half moulds, a first half mould 3, on which the glazing 1 rests, and a second half mould 4, which covers the glazing 1 and closes onto the first half mould 3. The two half moulds 3, 4 are self-sealing and fit together such that when the mould 2 is closed, a seal is formed between the two half moulds 3, 4 and the glazing 1. By using a self-sealing mould, polyurethane flashes around the edge of the gasket can be avoided. Each half mould 3, 4 has a moulding surface for moulding a gasket onto the glazing 1, shaped such that when the mould 2 is closed around the glazing 1, a cavity 5 is formed. The cavity 5 has the same shape and position on the glazing 1 as the final form of the gasket. A casting hole 6 is provided in the second half mould 4, to allow polyurethane to be injected into the mould 1.

Each half mould 3, 4, comprises a metal frame 7 filled with a plastic mould material, such as silicone 8. A releasable coating 9 of a self-sealing, flexible material is provided on the moulding surface of each half mould 3, 4. The releasable coating is one which does not react with the mould material, and hence remains chemically separate, acting as a barrier layer between the polyurethane formed in the mould during the injection moulding process and the silicone 8. Additionally or alternatively, the releasable coating is impermeable to the material used to mould the glazing. By using a material which prevents the infiltration of polyurethane into the surface pores of the silicone, and which does not bond or link with the silicone itself, the lifetime of the mould can be improved by at least 100%.

Preferably, the mould is designed in a ring shape. This allows a gasket to be moulded at any point on the periphery of the glazing, and reduces the weight of the mould. FIG. 2 shows a perspective view of a mould 2 to surround the periphery of a glazing 1. Again, the mould 1 comprises two half moulds 3, 4, which contact the periphery of the glazing 1, leaving the majority of the surface area of the glazing uncovered.

The half moulds 3, 4 are manufactured by casting the plastic mould material on a reproducible model, such that the plastic mould material reticulates on the model, creating the desired mould surface. Once the plastic mould material has solidified, the model is removed.

Before a gasket is moulded, the releasable coating 9 is applied to the surface of the half moulds 3, 4 by coating, for example, by spraying, dipping or painting, and any solvent evaporated off. If desired, the moulding surfaces of the half moulds may have a releasing agent applied before the releasable coating is applied. Such releasing agents are used to aid in the removal of the glazing from the mould once the gasket has hardened, and also to help remove any excess polyurethane which may be left on the surface of the glazing after moulding. Such releasing agents are removed from the gasket after moulding, and do not form part of the gasket.

The low-pressure injection method described in EP 0 792 209 B1 may then used to mould the gasket. A glazing 1 is then placed onto the first mould half 3, and the second mould half 4 placed on top, closing the mould 2 and sealing the glazing 1 into the mould 2. The mould 2 is then filled with polyurethane precursors under a pressure of less than 3 kg/cm², or at atmospheric pressure, in what is known as an open mould condition. The filling pressure is measured using a gauge at the point the precursors enter the mould. The precursors form the gasket by polymerisation and hardening. Preferably the filling composition comprises a prepolymer belonging to the family of reaction products between aromatic and/or aliphatic isocyanates modified so as to be in the liquid state between 25° C. and 35° C., and polyols (polyether and/or polyester and/or polycaprolactones). In order to obtain a polyurethane elastomer, such prepolymers are then reacted with an adequate amount of chain extender, chosen from aromatic compounds, aliphatic amines and/or short chain polyols having an NCO index in the range 1.00 to 1.10. The components are chosen to give a short gelling time (time taken to reach a viscosity that will not cast freely at 25° C.) of approximately 30 s at 25° C. Before filling, degassing is carried out. In addition, the first mould half 3 has an exit hole (not shown in the Figures) which is equal to or greater in size than the casting hole, so to encourage flow of the filling composition within the mould 2. The temperature within the mould is maintained by the exothermic polymerisation reaction between the components of the filling composition. The precursors contact the glazing and the releasable coating on filling of the mould, but do not come into contact with the moulding surface to which the releasable coating 9 has been applied as this is prevented by the releasable coating 9.

During the polymerisation process, the releasable coating 9 bonds with the reacting polyurethane precursors, and is incorporated into the moulded gasket. The releasable coating 9 forms the surface layer of the gasket, and therefore the properties of the releasable coating 9 determine the surface finish and/or properties of the gasket. For example, the releasable layer may impart improved resistance to damage to the gasket by UV light; improved weather resistance; a textured, matte or gloss surface finish; abrasion resistance properties; or a surface colour. The releasable coating is one of: aqueous solutions of waxes; aqueous solutions of polyurethane resins; hydro-alcoholic solutions of polyurethane resins; aqueous solutions of aliphatic polyurethane resins; or aqueous solutions of acrylic resins.

The glazing 1 may be a laminated glazing (comprising two plies of annealed or semi-toughened glass having an interlayer laminated in between) or may comprise a single ply glazing, of toughened or semi-toughened glass. Additionally, the glazing may be printed or comprise a coating.

As an alternative to the mould design shown in FIGS. 1 and 2, where both of the half moulds are formed of a resilient material having a releasable coating on their moulding surfaces, one of the half moulds may be replaced with a metal mould. By using one half mould formed of a resilient material such as silicone, any pressure on the glazing when the mould closes, which may damage or break the glazing, is absorbed. As a further alternative, one of the half moulds may be replaced with a rigid support that plays no part in the moulding of the gasket. The support is provided merely to support the glazing during the moulding process, and the cavity defining the gasket to be moulded onto the glazing is provided entirely by the moulding surface of one half mould. It may also be desirable to remove the support, and to place the glazing onto the half mould in an inverted position, effectively providing a single mould, suitable for use with other moulding techniques, such as that described in DE 41 03 047. In each case, the moulding surface is formed from a resilient material, such as silicone, and provided with a releasable coating that prevents the polyurethane precursors used to mould the gasket from contacting the moulding surface of the mould to which the coating has been applied. However, the polyurethane precursors are still able to contact the glazing in the region where the gasket is to be formed. Regardless of the type of metal mould, support used (if any) the gasket is formed by allowing the polyurethane precursors to polymerise and harden after contact with the glazing to form the gasket required.

As an alternative to using silicone as the mould material, any other suitable plastics material, such as polyurethane, may be used instead.

In addition to moulding the gasket, other preformed parts can be placed within the mould in order to be bonded to a surface of the glazing by the polyurethane. For example, one of the half moulds 3, 4 may have additional cavities for receiving locating pins, finishers, inserts, mirror bosses and the like, which are then contacted with the surface or edge of the glazing when the mould is closed.

The mould described above is suitable for use with a variety of automotive glazings, such as windscreens, rooflights, backlights, sidelights, and any other glazing used in automotive vehicles.

1-9. (canceled)

10. A method of providing the periphery of a glazing with a gasket by moulding using a mould of a plastics material having at least one moulding surface, comprising:
forming the gasket from polyurethane precursors by contacting the glazing with the precursors and allowing the precursors to polymerise and harden;
the moulding surface of the mould being provided with a releasable coating in an aqueous solution, the coating bonding with the polyurethane during the polymerisation such that the coating is incorporated into the gasket, the coating preventing the polyurethane from coming into contact with the moulding surface to which the polyurethane has been applied, and wherein the releasable coating does not react with the moulding surface of the half mould to which it is applied.

11. The method of claim 10, wherein the mould comprises complementary first and second half moulds, each half mould having a moulding surface for moulding the gasket onto the periphery of the glazing, the method further comprising:
placing a glazing between the complementary first and second half moulds;
closing the complementary first and second half moulds together and sealing the glazing between them such that the moulding surfaces form a cavity corresponding to the gasket to be moulded;
filling the cavity with polyurethane precursors;
allowing the polyurethane precursors to polymerise and harden; and
removing the glazing from between the complementary first and second half moulds, the removed glazing having a gasket moulded thereon.

12. The method of claim 10, wherein the polyurethane precursors comprise: (a) prepolymer composition formed from a reaction product of isocyanate and polyols, and (b) a chain extender.

13. The method of claim 12, wherein the polyurethane precursors form a mix having a short gelling time and enter the mould under low or atmospheric pressure.

14. The method of claim 10, wherein the releasable coating is one of: aqueous solutions of waxes; aqueous solutions of polyurethane resins; hydro-alcoholic solutions of polyurethane resins; aqueous solutions of aliphatic polyurethane resins; or aqueous solutions of acrylic resins.

15. The method of claim 10, wherein the moulding surface of the mould half having the releasable coating applied is formed from silicone.

16. The method of claim 10, wherein the releasable coating is applied to the mould half by spraying, dipping or painting.

17. The method of claim 10, wherein the aqueous solvent is evaporated off before placing the glazing into the mould.

18. The method of claim 11, wherein the polyurethane precursors comprise: (a) prepolymer composition formed from the reaction product of isocyanate and polyols, and (b) a chain extender.
